(19) United States
(12) Patent Application Publication
(10) Pub. No.: US 2014/0129605 A1
(43) Pub. Date: May 8, 2014

(54) SOCIAL NETWORK PLATFORM BASED ON ELECTRONIC MAPS

(71) Applicant: Wei-Hsin Huang, Taichung City (TW)

(72) Inventor: Wei-Hsin Huang, Taichung City (TW)

(21) Appl. No.: 13/670,422

(22) Filed: Nov. 6, 2012

(51) Int. Cl. G06F 15/16

(52) U.S. Cl. 709/201

(57) ABSTRACT

A social network platform based on electronic maps includes at least an electronic device, a network system and a server, the electronic device having a client application program connected to the server via the network system to read, upload or download an interactive message, the server having a database and an electronic map module, the database saving the interactive messages received by the server, the user defining a searching condition via the client application program to cut off a section of a map picture from the electronic map module, each interactive message which is located at where the map picture corresponds to being shown and labeled on the map picture, the user reading, replying or downloading the interactive messages which are shown on the map picture. Under this arrangement, the users continuously share feelings and make discussions about what the users interest in, so that the users expand interpersonal relationships.

### BACKGROUND OF THE INVENTION

1. Field of the Invention

The present invention relates to a social network platform, and more particularly to a social network platform based on electronic maps.

2. Description of Related Art

Being a nature, human beings live together. In fact, making friends is undoubtedly one of social activities among people. The people thank to the invention of internets and communication technologies, which make people easily making friends because it is not restricted by time and space.

New ways for making friends have appeared via the internets, and are called as network platforms of making friends, such as blogs, instant message software and platforms, online games, social network platforms, websites of friend making and Bulletin Board Systems.

To use a conventional network platform for making friends, a user firstly subscribe a membership and the user defines a username and a password for the membership so as to login in the network platform and to be a member; then, the user searches another member in the network platform according to location, username or mail address of another member, and/or other searching condition of another member; thereafter, the user sends a message to another member; as a result, the user makes a friendship with another member in the network platform.

However, it is difficult to make two strange people make friends with each other even when the two strange people are doing the same activity or are staying at the same place, because of an alienation feeling among the strange people in the real world, and the alienation feeling is particularly obvious in said network platforms. Actually, a user who would interact with another user on the network platforms might know each other in the real world mostly. Although the user would interact with the other user on the internets, the user doesn't know the other user in the real world, so that they would not make friends with each other.

In addition, it is complicated to operate the websites for making friend. Typically, the user would subscribe a membership from said websites firstly; then, the user choose a certain user from a member list provided by said websites and build a virtual friendship with the certain user within said websites. However, the information of the certain user provided by said websites is poor so that the user cannot interact with the certain user easily.

The present invention has arisen to mitigate and/or obviate the disadvantages of the conventional.

### SUMMARY OF THE INVENTION

The main objective of the present invention is to provide a social network platform based on electronic maps.

To achieve the objective, a social network platform based on electronics maps comprises at least one electronic device, a network system and a server, the electronic device having a network platform, the electronic device having a client application program installed therein, the client application program connected to the server via the network platform of the electronic device and the network system, so as to input a plurality of commands or information or progress, the commands comprising an identity authentication module and a means of reading, uploading and downloading interactive messages, the identity authentication module defined in the client application program so as to input personal information of a user to the client application program, subscribe a username, set a password and login in, so that the user reads, downloads or uploads an interactive message from the server, the server comprising a database and an electronic map module, the database saving the information and the interactive messages which are received by the server, the database connecting with the electronic map module, so that when the server receives the interactive message, the server defines a position label into the electronic map module, the position label corresponding to where the interactive message is sent from, the user inputting the personal information, the username and the password so as to login the client application program when the user uses the present invention first time, said personal information, username and password being saved in the database, said personal information, username and password being updated to the database after every revision, the interactive message being selectively set as a public message or a, private message, the interactive message being selectively set as a currently published message or a pre-defined message, the interactive message being selectively set as a message published in a single position or a message published in multi positions, the interactive message being selectively set as being readable by certain users only, when the user uploads the interactive message via the client application program, the electronic map module connects with the client application program of the electronic device via the network system, the user defining a searching condition via the client application program so as to cut off a section of a map picture from the electronic map module, each interactive message which is located at where the map picture corresponds to being shown and labeled on the map picture, the user reading, replying or downloading the interactive messages which are shown on the map picture, the user selectively uploading a new interactive message onto a designated position of the map picture, the database saving a plurality of interactive messages which are received in a same position as a group, so that the electronic map module updates a status and the contents of the interactive message on the map picture, the client application program having an advertising module, the advertising module connecting to the database and the electronic map module via the network system, a store selecting a certain map picture from the electronic map module via the advertising module and uploading an advertising web page, the store selecting another certain map picture which comprises a location of the store from the electronic map module and setting a store label on a corresponding position of another certain map picture, the advertising web page and the store label saved in the database. Wherein, the store label of the advertising module are set as an online shop so that the users buy goods directly from the online shop of the social network platform; the client application program further comprises an online shopping mechanism; the online shopping mechanism connects to the electronic map module and the database via the network system so that the user chooses a certain store label which is set as the online shop from the map picture of the electronic map module and buys goods from the online shop directly via the network system; a global positioning system is installed into the electronic device; the global positioning system defines the position of the electronic device; the position of the electronic device is determined by different received times of signals which are respectively received by several artificial satellites; wherein positioning information of the electronic device is delivered and saved to the database of the server; the positioning information of the electronic device is updated and saved to the database according to the next positioning information of the electronic device; the client application program further comprises a mine message mechanism; the mine message mechanism is connected to the electronic map module and the database via the network system so that the user progresses the client application program so as to choose a specific map picture from the electronic map module and pre-upload a specific interactive message to a specific user on an assigned point of the specific map picture; wherein when the positioning information of the specific user matches with the assigned point of the specific map picture, the specific interactive message is showed on the electronic device of the specific user automatically; the client application program further comprises a message replying setting mechanism; the message replying setting mechanism corresponds to the mine message mechanism, so that the specific user selectively replies a notification of receiving interactive messages to the user or not while the specific user receives the specific interactive message; the format of the interactive message is selectively set as a document file, a picture file, a video file, an audio file, a hyperlink file or a combination of said files; the format of the advertising web page and the store label is selectively set as another document file, another picture file, another video file, another audio file, another hyperlink file or another combination of said files; the electronic device is selectively set as a mobile phone, a tablet computer, a laptop computer, a desktop computer, a hand-held videogame, a television game, a navigation device or other devices; the electronic device is connectable to the network system and has a global positioning function; each interactive message has a user code so that the server identifies the user codes of the users who belong to the same group where the interactive messages are labeled in the same position via the users, so that the server sends a notification of new interactive messages to the client application program of each user who is within said group when the contents of the interactive messages in the group are renewed or when a new interactive message is published in the group; the client application program comprises a push function so that the user sets the push function, and inputs an email address via the authentication module; as a result, the email address is saved in the database; wherein when the user is not login to the social network platform, the notifications of new interactive messages from the server would be sent to the email address.

Under this arrangement, the users selectively reads, publishes or replies the interactive messages so as to continuously share feelings and make discussions about what the users interest in, so that the users expand interpersonal relationships; in addition, popularities of the stores is increased among social networks via the advertising module so that the users purchases goods directly on line.

Further benefits and advantages of the present invention will become apparent after a careful reading of the detailed description with appropriate reference to the accompanying drawings.

### BRIEF DESCRIPTION OF THE DRAWINGS

FIG. 1 is a block chart for showing a relationship between an electronic device, a network platform, and a network system of a social network platform based on electronic maps of the present invention;

FIG. 2 is schematic view of the social network platform;

FIG. 3 is a block chart for showing relationships between a client application program, a database and an electronic mapping module;

FIG. 4 is a block chart for showing a relationship between the client application program and the electronic map module;

FIG. 5 is a block chart for showing relationships between an advertising module, the electronic map module and the database;

FIG. 6 is a block chart for showing a process where the server sends a notification of new interactive messages to the user;

FIG. 7 is a block chart for showing a mine message mechanism delivers a specific interactive message to a specific electronic device; and

FIG. 8 is a block chart for showing that a message replying setting mechanism selectively replies a notification of receiving interactive messages or not.

### DETAILED DESCRIPTION OF THE INVENTION

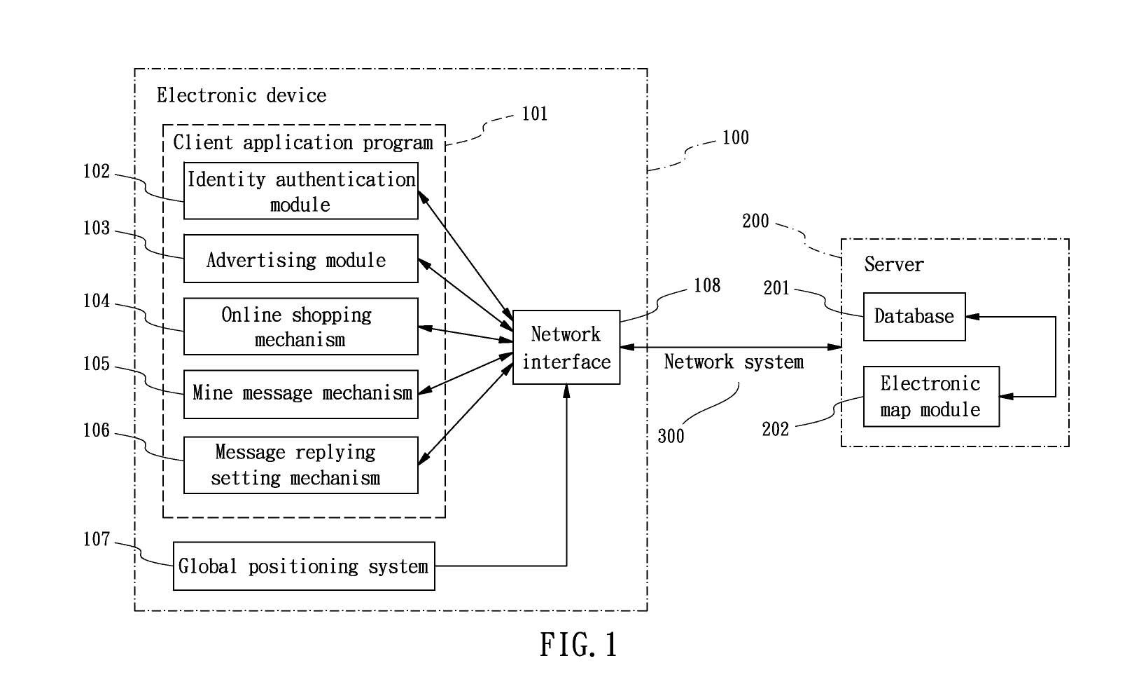

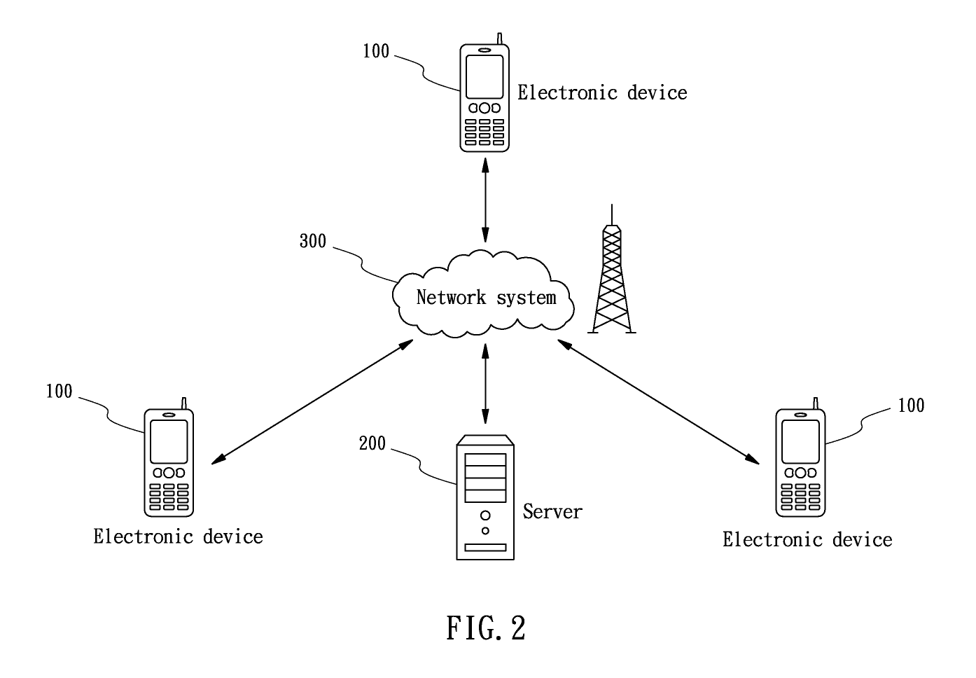

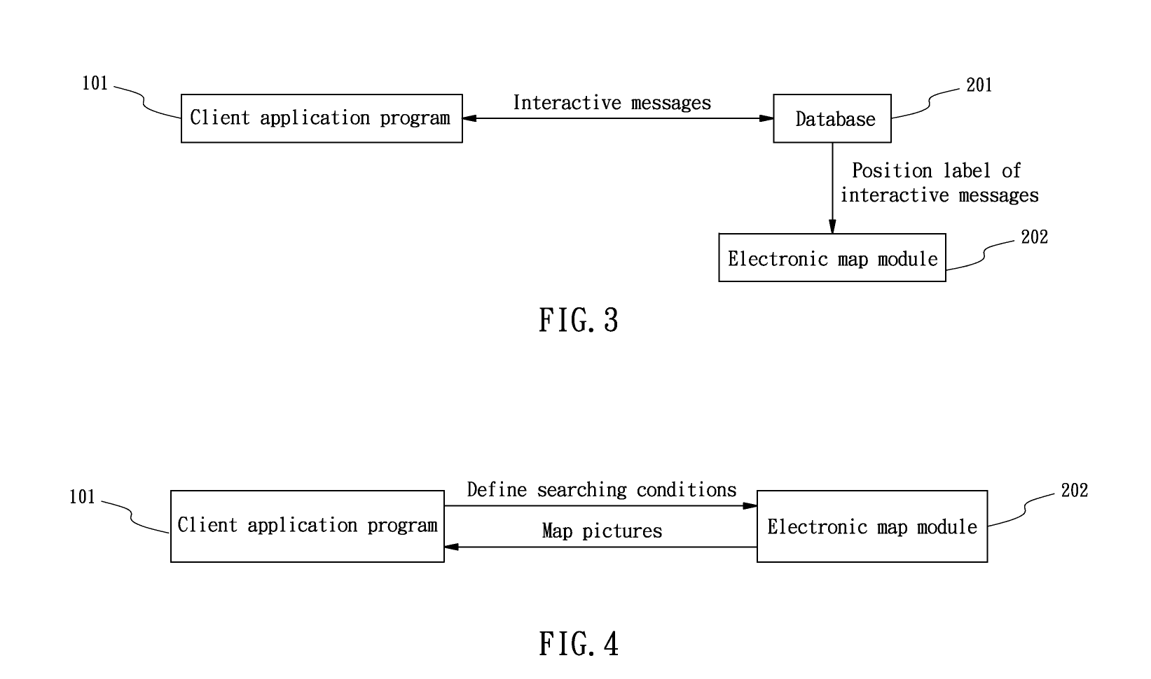

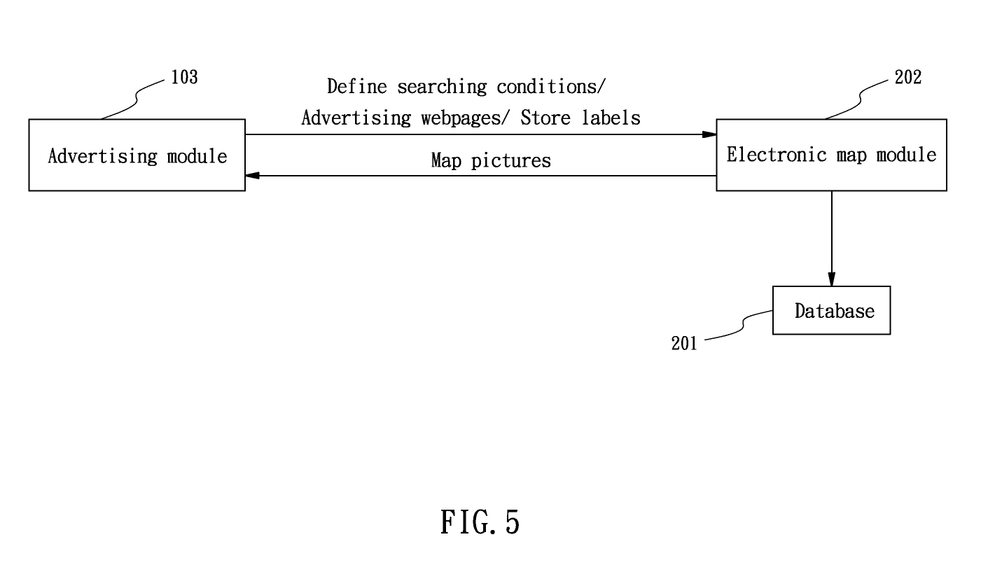

Referring to FIGS. 1-5, a social network platform based on electronic maps in accordance with the present invention comprises at least one electronic device 100, a network system 300 and a server 200.

The electronic device 100 could be a mobile phone, a tablet computer, a laptop computer, a desktop computer, a hand-held videogame, a television videogame, a navigation device or other devices. The electronic device 100 is connectable to the network system 300 and has a global positioning function. The electronic device 100 has a network platform 108 (The embodiment of the electronic device 100 is not limited by the present invention). In a preferred embodiment, the electronic device 100 is the mobile phone. The mobile phone has a client application program 101 installed therein. The client application program 101 connects to the server 200 via the network platform 108 of the mobile phone and the network system 300, so as to input a plurality of commands or information. The commands comprise an identity authentication module 102 and a means of reading, uploading and downloading interactive messages. The identity authentication module 102 is defined in the client application program 101 so as to input personal information of a user to the client application program 101, subscribe a username, set a password and log in, so that the user could reads, downloads or uploads an interactive message from the server 200. The interactive message could be entered via keyboards, buttons, computer mouse or touch pens. The interactive messages could also be entered by voice of the user. The format of the interactive message could be a document file, a picture file, a video file, an audio file, a hyperlink file or a combination of said files.

The server 200 comprises a database 201 and an electronic map module 202. The database 201 saves the information and the interactive messages which are received by the server 200. The database 201 connects with the electronic map module 202, so that when the server 200 receives the interactive message, the server 200 would define a position label into the electronic map module 202. The position label corresponds to where the interactive message is sent from.

When the user uses the present invention at first time, the user inputs the personal information, the username and the password so as to login the client application program 101. Thereafter, said personal information, username and password are saved in the database 201. Said personal information, username and password are updated in the database 201 after every revision. When the user uploads the interactive message via the client application program 101, the interactive message is selectively set as a public message or a private message; the interactive message is selectively set as a currently published message or a pre-defined message; the interactive message is selectively set as a message published in a single position or a message published in multi positions; the interactive message is selectively set as being readable by certain users only. The electronic map module 202 connects with the client application program 101 of the electronic device 100 via the network system 300. The user defines a searching condition via the client application program 101 so as to cut off a section of a map picture from the electronic map module 202. Each interactive message which is located at where the map picture corresponds to is shown and labeled on the map picture. The user reads, replies and/or downloads the interactive messages which are shown on the map picture. The user could also upload a new interactive message onto a designated position of the map picture. The database 201 saves a plurality of interactive messages which are received in the same position as a group, so that the electronic map module 202 updates a status and the contents of the interactive message on the map picture.

The client application program 101 has an advertising module 103. The advertising module 103 connects to the database 201 and the electronic map module 202 via the network system 300. A store selects a certain map picture from the electronic map module 202 via the advertising module 103 and uploads an advertising web page onto the certain map picture. The store could also select another certain map picture which comprises a location of the store from the electronic map module 202 and set a store label on a corresponding position of another certain map picture. The format of the advertising web page and the store label could be another document file, another picture file, another video file, another audio file, another hyperlink file or another combination of said files. The advertising web page and the store label are saved in the database 201.

Under this arrangement, the user operates the present invention via the following steps.

The user connects to the network system 300 via the mobile phone firstly; then, the user inputs the username, the password and the personal information via the client application program 101 when the user applies the present invention at the first time; and then, when the user logins, the username and the password are checked by the identity authentication 102 to be the same as a default setting (information checking process are wildly applied among social network programs, so that the description about a procedure of the information checking process would not be further described); thereby, in a public manner wherein the user and the other users could read the interactive messages freely, or in a private manner wherein the interactive messages could only be read by the user, the user leaves the interactive messages which are selectively chosen as currently published messages or pre-defined messages on at least one designated map picture via the client application program 101. For instance, the user would upload a photograph of a sky view which is just taken at a balcony of an office of the user a few seconds ago, or the user would upload an invitation message at a theater for inviting other people to see a movie, or the user would also upload some texts simultaneously about emotional feelings of the user at multi positions; therefore, the other user who is interested in what the user uploads would comment on the photograph, or would reply a message immediately for showing a willingness about seeing the movie with the user, or would leave some words to the user for showing a reply to the user.

The searching condition could be defined according to addresses, streets, buildings, regions or landmarks which are related to the electronic map module 202 or be defined according to publish times of the interactive messages, keywords of the interactive messages, the interactive messages published in certain time periods which are related to the database 201. Under this arrangement, the user could choose only one searching condition, or the user could also use a union/or an intersection of the searching conditions for selecting the map pictures and/or the interactive messages which are conformed to the searching conditions. For instance, once the user uses the union of key words like “New York, Times Square, October, cultural activities” for selecting the map pictures and the interactive messages; as a result, all of the map pictures and the interactive messages which are related to the cultural activities held on October in Times Square of New York would be figured out. A range of the map pictures could be adjusted according to the needs of the user. When the interactive messages displayed on the map pictures are not enough, the user could enlarge the range of the map pictures; in contrast, when the interactive messages displayed on the map pictures are too many, the user could reduce the range of the map pictures.

The database 201 labels and updates the status of the interactive messages on the map pictures according to the position labels of the interactive messages, so that the users continuously share feelings and make discussions about what the users interest in. Under this arrangement, the users expand interpersonal relationships.

According to said searching conditions, the store chooses at least one map picture from the electronic map module 202 via the advertising module 103 and uploads the advertising web page on a designated position of the chosen map picture. For example, stores like Starbucks Coffee or even those stores without physical storefronts would choose a certain ranged map picture firstly which is preferred as being the map picture full of interactive messages being representing a high density of users in the certain range; and then, the stores upload a plenty of advertising web pages which are related to information about new products, products with special prices or bargained activities on said map picture. In addition, the stores would choose the map picture which contains the locations of the stores from the electronic map module 202 and set store labels on the corresponding positions of said map picture. The format of the advertising web page and the store label could be a document file, a picture file, a video file, an audio file, a hyperlink file or a combination of said files. The advertising web page and the store label are saved in the database 201.

Under this arrangement, popularities of the stores could be increased among social networks via the advertising module 103; in addition, the cost of producing real advertising campaign items and the cost of building physical storefronts are both reduced. Moreover, after the users read the contents about the advertising web pages or the store labels on the map pictures, the users would purchase goods directly on line.

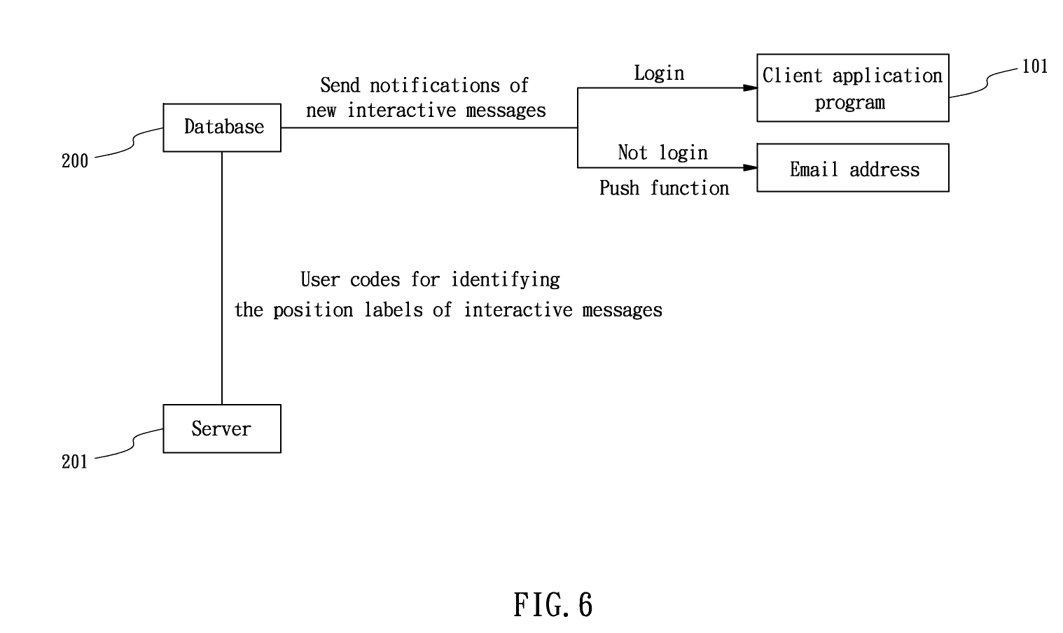

Referring to FIGS. 6-8, the further details of the present invention are shown as following:

1. Referring to FIG. 6, each interactive message has a user code so that the server 200 identifies the user codes of the users who belong to the same group where the interactive messages are labeled in the same position via the users, so that the server sends a notification of new interactive messages to the client application program 101 of each user who is within said group when the contents of the interactive messages in the group are renewed or when a new interactive message is published in the group. The server 200 updates the contents and the status of the interactive messages on the map picture of the electronic map module 202 according to sending positions of said notifications and the database 201 groupingly saves the interactive messages which are received in the same position. Besides, when the status of the interactive messages within the group is updated, the server 200 sends the notification of new interactive messages to the users within the group. For example, originally a position called Park has three interactive messages named M1, M2 and M3 which are published by users named Ken and Any. If a new user called Mike publishes a new interactive message called M4 to the position, the server 200 will send a notification of the new interactive message M4 to Ken and Any; in another condition, if Amy publishes a further new interactive message named M5, the server 200 will send another notification of the new interactive message M5 to Ken. Each notification of new interactive messages is displayed on the client application program 101 of related users.

Moreover, the client application program 101 further comprises a push function. The user sets the push function, and inputs an email address via the authentication module 102; as a result, the email address is saved in the database 201. Under this arrangement, when the user is not login to the social network platform, the notifications of new interactive messages from the server 200 would be sent to the email address, so that the user could follow newest statuses of the interactive messages in the social network platform.

2. The store label of the advertising module 103 could be set as an online shop so that the users buy goods directly from the online shop of the social network platform. The client application program 101 further comprises an online shopping mechanism 104. The online shopping mechanism 104 connects to the electronic map module 202 and the database 201 via the network system 300 so that the user chooses a certain store label which is set as the online shop from the map picture of the electronic map module 202 and buys goods from the online shop directly via the network system 300. For instance, when the user chooses the store label of Amazon and enters into the online shop of the Amazon, the user could buy a book and some digital products via the online shopping mechanism 104.

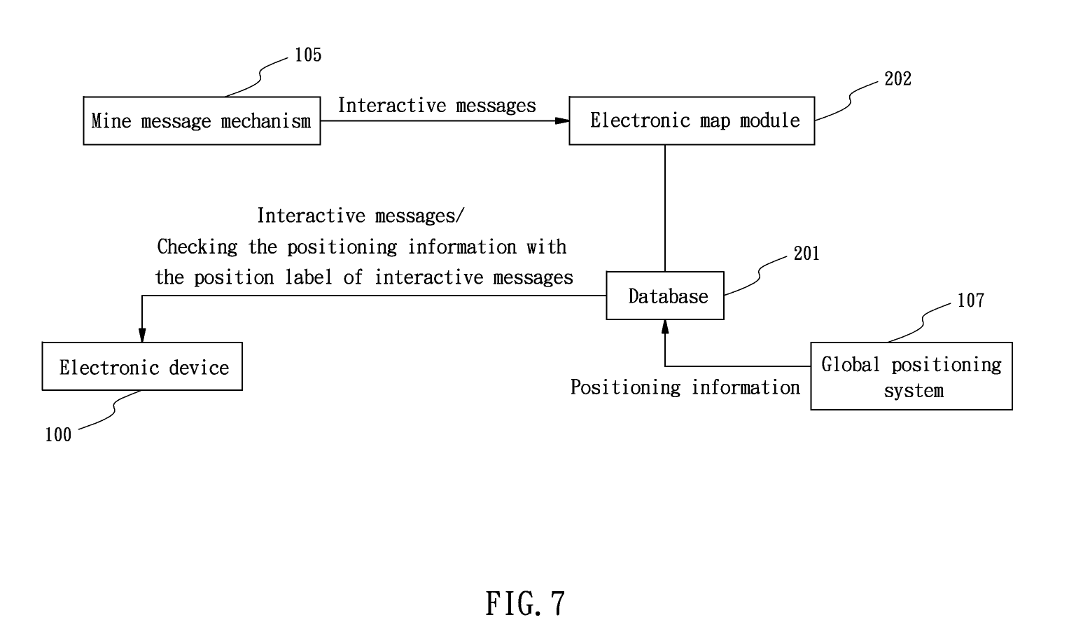

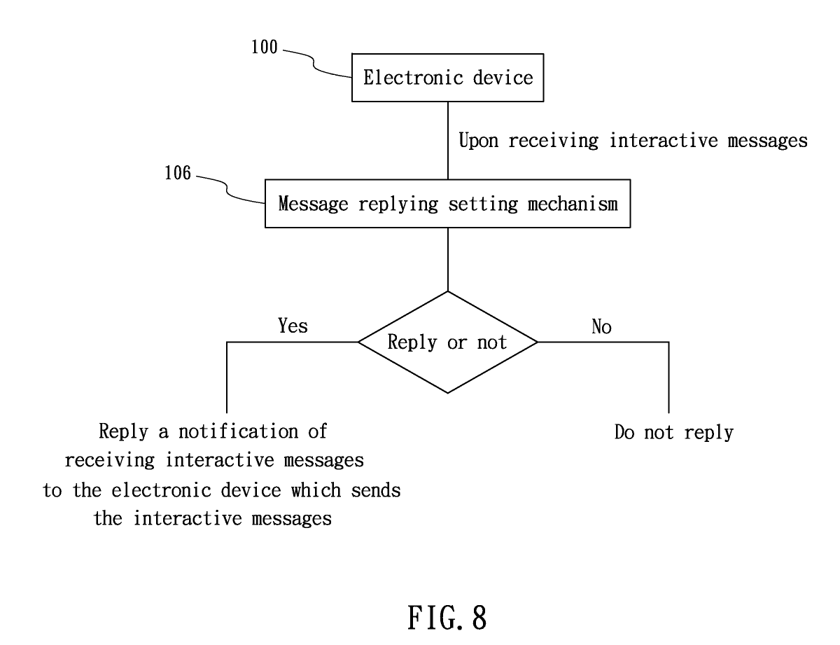

3. Referring to FIGS. 7-8, a global positioning system 107 is installed into the mobile phone. The global positioning system 107 defines the position of the mobile phone. The position of the mobile phone is determined by different received times of signals which are respectively received by several artificial satellites. Under this arrangement, positioning information of the mobile phone is delivered and saved to the database 201 of the server 200; besides; the positioning information of the mobile phone is updated and saved to the database 201 according to the next positioning information of the mobile phone.

The client application program 101 further comprises a mine message mechanism 105. The mine message mechanism 105 is connected to the electronic map module 202 and the database 201 via the network system 300 so that the user progress the client application program 101 so as to choose a specific map picture from the electronic map module 202 and pre-upload a specific interactive message to a specific user on an assigned point of the specific map picture. Under this arrangement, when the positioning information of the specific user matches with the assigned point of the specific map picture (The server 200 would check the position label of the specific interactive message with the positioning information of the specific user; the positioning information of the specific user is defined by the global positioning system 107), the specific interactive message will show on the electronic device 100 of the specific user automatically. For example, one user would leave one interactive message to another user for greeting via the mine message mechanism 105 on a destination of another user, so that when the position global positioning system 107 shows that the poisoning information of another user matches the position label of the destination of another user, the electronic device 100 of another user shows said interactive message automatically.

The client application program 101 further comprises a message replying setting mechanism 106. The message replying setting mechanism 106 corresponds to the mine message mechanism 105, so that the specific user selectively replies a notification of receiving interactive messages to the user or not while the specific user receives the specific interactive message.

In order to protect personal privates, if the specific user would not reply the notification of receiving interactive messages to the user, the user does not know whether the specific user receives the specific interactive message or not.

Although the invention has been explained in relation to its preferred embodiment, it is to be understood that many other possible modifications and variations can be made without departing from the spirit and scope of the invention as hereinafter claimed.

What is claimed is:

1. A social network platform based on electronic maps comprising at least one electronic device, a network system and a server;
the electronic device having a network platform, the electronic device having a client application program installed therein, the client application program connected to the server via the network platform of the electronic device and the network system, so as to input a plurality of commands or information or progress;
the commands comprising an identity authentication module and a means of reading, uploading and downloading interactive messages, the identity authentication module defined in the client application program so as to input personal information of a user to the client application program, subscribe a username, set a password and login in, so that the user reads, downloads or uploads an interactive message from the server;
the server comprising a database and an electronic map module, the database saving the information and the interactive messages which are received by the server, the database connecting with the electronic map module, so that when the server receives the interactive message, the server defines a position label into the electronic map module, the position label corresponding to where the interactive message is sent from;
the user inputting the personal information, the username and the password so as to login the client application program when the user uses the present invention first time, said personal information, username and password being saved in the database, said personal information, username and password being updated to the database after every revision, the interactive message being selectively set as a public message or a private message, the interactive message being selectively set as a currently published message or a pre-defined message, the interactive message being selectively set as a message published in a single position or a message published in multi positions, the interactive message being selectively set as being readable by certain users only, when the user uploads the interactive message via the client application program, the electronic map module connects with the client application program of the electronic device via the network system, the user defining a searching condition via the client application program so as to cut off a section of a map picture from the electronic map module, each interactive message which is located at where the map picture corresponds to being shown and labeled on the map picture, the user reading, replying or downloading the interactive messages which are shown on the map picture, the user selectively uploading a new interactive message onto a designated position of the map picture, the database saving a plurality of interactive messages which are received in a same position as a group, so that the electronic map module updates a status and the contents of the interactive message on the map picture; and
the client application program having an advertising module, the advertising module connecting to the database and the electronic map module via the network system, a store selecting a certain map picture from the electronic map module via the advertising module and uploading an advertising web page, the store selecting another certain map picture which comprises a location of the store from the electronic map module and setting a store label on a corresponding position of another certain map picture, the advertising web page and the store label saved in the database;
wherein the users selectively reads, publishes or replies the interactive messages so as to continuously share feelings and make discussions about what the users interest in, so that the users expand interpersonal relationships; in addition, popularities of the stores is increased among social networks via the advertising module so that the users purchases goods directly on line.

2. The social network platform based on electronic maps as claimed in claim 1, wherein the store label of the advertising module are set as an online shop so that the users buy goods directly from the online shop of the social network platform; the client application program further comprises an online shopping mechanism; the online shopping mechanism connects to the electronic map module and the database via the network system so that the user chooses a certain store label which is set as the online shop from the map picture of the electronic map module and buys goods from the online shop directly via the network system.

3. The social network platform based on electronic maps as claimed in claim 1, wherein a global positioning system is installed into the electronic device; the global positioning system defines the position of the electronic device; the position of the electronic device is determined by different received times of signals which are respectively received by several artificial satellites; wherein positioning information of the electronic device is delivered and saved to the database of the server; the positioning information of the electronic device is updated and saved to the database according to the next positioning information of the electronic device;
the client application program further comprises a mine message mechanism; the mine message mechanism is connected to the electronic map module and the database via the network system so that the user progresses the client application program so as to choose a specific map picture from the electronic map module and pre-upload a specific interactive message to a specific user on an assigned point of the specific map picture; wherein when the positioning information of the specific user matches with the assigned point of the specific map picture, the specific interactive message is showed on the electronic device of the specific user automatically.

4. The social network platform based on electronic maps as claimed in claim 3, wherein the client application program further comprises a message replying setting mechanism; the message replying setting mechanism corresponds to the mine message mechanism, so that the specific user selectively replies a notification of receiving interactive messages to the user or not while the specific user receives the specific interactive message.

5. The social network platform based on electronic maps as claimed in claim 1, wherein the format of the interactive message is selectively set as a document file, a picture file, a video file, an audio file, a hyperlink file or a combination of said files.

6. The social network platform based on electronic maps as claimed in claim 1, wherein the format of the advertising web page and the store label is selectively set as another document file, another picture file, another video file, another audio file, another hyperlink file or another combination of said files.

7. The social network platform based on electronic maps as claimed in claim 1, wherein the electronic device is selectively set as a mobile phone, a tablet computer, a laptop computer, a desktop computer, a hand-held videogame, a television game, a navigation device or other devices; the electronic device is connectable to the network system and has a global positioning function.

8. The social network platform based on electronic maps as claimed in claim 1, wherein each interactive message has a user code so that the server identifies the user codes of the users who belong to the same group where the interactive messages are labeled in the same position via the users, so that the server sends a notification of new interactive messages to the client application program of each user who is within said group when the contents of the interactive messages in the group are renewed or when a new interactive message is published in the group.

9. The social network platform based on electronic maps as claimed in claim 8, wherein the client application program comprises a push function so that the user sets the push function, and inputs an email address via the authentication module; as a result, the email address is saved in the database; wherein when the user is not login to the social network platform, the notifications of new interactive messages from the server would be sent to the email address.
